(19) United States
(12) Patent Application Publication
(10) Pub. No.: US 2024/0066854 A1
(43) Pub. Date: Feb. 29, 2024

(54) METHOD FOR MANUFACTURING A FLEXIBLE SURFACE ELEMENT AND A SURFACE ELEMENT MANUFACTURED THEREBY

(71) Applicant: Forbo Siegling GmbH, Hannover (DE)

(72) Inventors: Lennart Schulz, Hannover (DE); Markus Nadler, Lehrte (DE); Vadim Molochnikov, Hannover (DE); Torsten Buch, Wedemark (DE)

(21) Appl. No.: 18/454,921

(22) Filed: Aug. 24, 2023

(30) Foreign Application Priority Data
Aug. 24, 2022 (DE) 10 2022 121 413.3

(51) Int. Cl. B32B 38/00; B32B 3/26; B32B 5/18; B32B 27/36; B32B 38/10

(52) U.S. Cl. CPC B32B 38/0032; B32B 3/266; B32B 5/18; B32B 27/36; B32B 38/0036; B32B 38/10; B32B 2305/028; B32B 2307/518; B32B 2307/584

(57) ABSTRACT

A method for manufacturing a flexible surface element with at least one thermoplastic, thermosetting and/or elastomeric wear layer is provided. The method includes introducing expandable hollow microspheres into the wear layer and/or a functional layer, applying at least one pressure-resistant layer detachably to the wear layer, and subsequently heating at least one section of the surface element to be treated by a thermal energy supply to a temperature within an expansion temperature range of the hollow microspheres, so that at least the hollow microspheres contained in the section to be treated are at least partially expanded and/or further expanded. Expansion of the hollow microspheres is limited by pressure-resistant properties of the pressure-resistant layer. The method further includes removing the pressure-resistant layer from the wear layer at least sectionally.

### CROSS REFERENCE TO RELATED APPLICATIONS

This application claims benefit to German Patent Application No. DE 10 2022 121 413.3, filed on Aug. 24, 2022, which is hereby incorporated by reference herein.

### FIELD

Embodiments of the present invention relate to a method for manufacturing a flexible surface element having at least one inner or outer thermoplastic wear layer. Embodiments of the present invention also relate to a flexible surface element manufactured in such a way.

### BACKGROUND

It is generally known to foam thermoplastics using blowing agents. Expandable hollow microspheres, for example, are hereby used as blowing agents.

Such expandable hollow microspheres, also known as micro balloons, consist of a thin plastic shell, for example polyacrylonitrile or copolymer, and are filled with gas, usually with hydrocarbons. The temperature acting in the thermoplastic processing results in a softening of the plastic shell and simultaneously in an expansion of the enclosed gas. This results in expansion of the hollow microspheres. Also combinations of chemical blowing agents and expandable hollow microspheres are used.

The manufacture and use of expandable thermoplastic hollow microspheres are disclosed, for example, in U.S. Pat. No. 3,615,972 A. The unexpanded spheres contain volatile liquid blowing agents that change to the gaseous state after application of heat. When heat is applied, the polymer shell softens and the spheres expand as the blowing agent becomes gaseous.

EP 0 348 372 B1 describes a method, in which the unexpanded hollow microspheres are expanded using a hot blower and an exhaust device, for example, via infrared radiation.

There are also methods known for foaming thermoplastic polyurethanes with blowing agents. In the case of thermoplastic polyurethane, chemical blowing agents lead to a comparatively very coarse foam structure and to an increased formation of cavities.

To remedy this deficiency, EP 0 692 516 A1 describes a method for the manufacture of foams based on thermoplastic polyurethane, in which a mixture of chemical blowing agents and hollow microspheres is used as blowing agent.

U.S. Pat. No. 6,103,152 A relates to a method for the manufacture of a polymer foam, wherein a molten polymer composition is mixed with expandable polymeric microspheres, which are expanded in the polymer composition, before the composition exits the nozzle. After exiting the nozzle, the microspheres can be further expanded by heating the polymer foam. The polymer foam can have a substantially smooth surface and can also be produced as a sheet.

From US 2006/0 219 350 A1 an adhesive composition is known, which is placed between surfaces or layers and contains two thermo-expandable microsphere species, wherein a first species of microsphere serves for hardening and a second species of microsphere serves for debonding. The microspheres of the different species are activatable at different temperatures.

U.S. Pat. No. 5,783,302 A describes a calendering system that can be used to produce in situ foamable thin sheets. The sheet contains a liquid blowing agent or expanding agent. The resin matrix may contain hollow glass microspheres.

EP 2 134 425 B1 relates to the use of an endless belt as a treadmill for running training equipment. Foaming can be carried out by adding expandable microspheres to the thermoplastic material, whereby the foamed layer thus obtained can then be applied to the tensile member in a second process step by means of calendering.

During manufacturing of the flexible surface elements, in practice, the reduced surface quality or also sectionally different surface quality of the wear layer often proves to be a disadvantage In particular, unevenness, micropores or cavities cannot be reliably ruled out. In addition, the limited dimensional accuracy of such surface elements, for example, as a result of continued expansion of the hollow microspheres after calendering, is a hindrance.

### SUMMARY

Embodiments of the present invention provide a method for manufacturing a flexible surface element with at least one thermoplastic, thermosetting and/or elastomeric wear layer. The method includes introducing expandable hollow microspheres into the wear layer and/or a functional layer, applying at least one pressure-resistant layer detachably to the wear layer, and subsequently heating at least one section of the surface element to be treated by a thermal energy supply to a temperature within an expansion temperature range of the hollow microspheres, so that at least the hollow microspheres contained in the section to be treated are at least partially expanded and/or further expanded. Expansion of the hollow microspheres is limited by pressure-resistant properties of the pressure-resistant layer. The method further includes removing the pressure-resistant layer from the wear layer at least sectionally.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 a surface element according to embodiments of the invention with a wear layer during the heating of the hollow microspheres contained in the wear layer;

FIG. 2 the surface element after the expansion of the hollow microspheres with a wear layer compressed against a pressure-resistant layer according to some embodiments; and

FIG. 3 the surface element after removal of the pressure-resistant layer according to some embodiments.

### DETAILED DESCRIPTION

Embodiments of the invention provide a method for manufacturing a surface element with substantially improved properties of the wear layer. Embodiments of the invention produce a thus manufactured flexible surface element with improved properties of the wear layer.

Thus, according to embodiments of the invention, a method is provided for manufacturing a flexible surface element with an outer and/or inner thermoplastic, thermosetting or elastomeric wear layer, in which the expandable hollow microspheres are introduced with a preferably homogeneous distribution, at least one additional pressure-resistant layer being detachably applied to the wear layer and subsequently at least one section of the surface element to be treated being heated by thermal energy supply, preferably uniformly, to a specific temperature within an expansion temperature range below an upper limit temperature of the hollow microspheres, so that at least the hollow microspheres contained in the section to be treated and/or already partially expanded hollow microspheres are at least partially expanded, the expansion of the hollow microspheres being limited by the pressure-resistant properties of the pressure-resistant layer in that a balance is established between the expansion pressure and the counterpressure of the pressure-resistant layer, the material thickness of the wear layer being reduced by the expansion and the pressure-resistant layer subsequently being removed from the wear layer at least in sections.

According to embodiments of the invention, a pressure-resistant layer is understood to be a flexible but tension-resistant, non-elastic and at most plastically expandable layer that is suitable for withstanding the expansion pressure in order to limit the expansion with dimensional accuracy. On the basis of these properties, the pressure-resistant layer can be described as tension-resistant.

In a typical form of application of the method according to embodiments of the invention, uniform heating of the flexible surface element and thus of the thermoplastic wear layer takes place. As a result of the expansion of the hollow microspheres, compression of the wear layer can occur. In this case, the pressure-resistant layer acts as a cover sheet to counteract the expansion. It has already been shown that this homogenizes even the smallest irregularities on the upper surface of the wear layer, so that the upper surface has a so-called mirror-surface quality after removal of the pressure-resistant layer. This opens up completely new application possibilities for the surface element, for example, in the printing industry. In addition, also the material thickness of the surface element can be specifically adjusted by controlling the temperature with high, reproducible accuracy.

An advantageous embodiment of the invention is achieved by removing the pressure-resistant layer holohedrally from the wear layer after expansion of the hollow microspheres. The surface finish of the thus exposed wear layer then corresponds to the surface finish of the facing side of the pressure-resistant layer and achieves highest quality requirements in practice. Naturally, textures or patterns can also be transferred onto the wear layer via the pressure-resistant layer as a negative of the corresponding condition of the pressure-resistant layer.

Thereby it has proved advantageous if the pressure-resistant layer has a sheet, in particular of polyester, as a material component and preferably a constant material thickness. Alternatively, regions with different material thicknesses can also be provided, for example, to allow for limited elasticity of the pressure-resistant layer in individual regions, which leads to local elevations in the wear layer.

Furthermore, by means of the pressure-resistant layer, certain materials or substances can be transferred on or in the upper surface of the wear layer or remain on the wear layer when the pressure-resistant layer is removed.

It is conceivable to configure the pressure-resistant layer as a metal sheet, which, if necessary, is also reusable multiple times. Preferably, the pressure-resistant layer has a biaxially and/or bidirectionally pre-stretched sheet which is also used, for example, as a protective sheet and is only removed from the wear layer before the use of the surface element.

Another, also promising variant of the method is created in that the energy input during heating of the section of the surface element to be treated to a temperature above the expansion temperature is varied partially or in sections. This creates at least one region with a lower energy input and at least one further region with a raised energy input. In accordance with the spatial expansion limited by the pressure-resistant layer, this results in a different compaction in the different regions and consequently results in regions of the surface element with different densities. As a result, other mechanical properties, such as flexibility, also differ in the regions. In practice, this can create flexible zones that prove advantageous for applications such as conveyor belts used in the areas of redirections.

Another practical embodiment of the invention is achieved by removing and/or modifying the pressure-resistant layer partially or in sections before, during or after the heating of the wear layer by the energy input. For example, the pressure-resistant layer can be cut out, perforated or weakened by mechanical tools or by laser radiation, so that in these regions the wear layer is elevated or is formed convexly. By subsequently modifying the pressure-resistant layer already adhering to the wear layer, it is possible to create individual textures of the wear layer.

In this case, the detachable connection of the pressure-resistant layer and the wear layer is realized, for example, by means of an adhesive bond.

In another advantageous variant of the method according to embodiments of the invention, several, in particular different, pressure-resistant layers are detachably applied to the wear layer, whereby the different layers can in particular also cover different subregions. By using several pressure-resistant layers, the expansion of the wear layer and thereby the material thickness of the surface element thus produced can be adjusted. For example, regions with a lower number of pressure-resistant layers are thereby elevated compared to other regions with a higher number of pressure-resistant layers, so that local depressions and elevations can be realized.

Similarly, individual pressure-resistant layers can have cutouts or through-holes, for example with a pattern, which can be transferred to the wear layer accordingly.

The thermal energy can be selectively applied to different regions delineated from each other, in the forms of tracks running in a longitudinal direction, sections running in a transverse direction, and/or planes running in different cross-sectional planes of the surface element, with different wavelengths or intensities, so that the hollow microspheres are expanded differently in the different regions.

Thus, by selectively activating the hollow microspheres bonded in a material of the surface element forming the matrix for the hollow microspheres, after completion of the surface element, which may, for example, also have other decorative or functional layers in addition to the wear layer, expansion of the hollow microspheres occurs as a function of the energy input. In this way, material properties, such as damping or dimensional stability, can be set with high accuracy in conjunction with the pressure-resistant layer, while the outer contour, in particular the thickness, of the surface element is limited by the pressure-resistant layer, thus ensuring a high dimensional accuracy of the surface element. Hereby the term “region” is to be understood as a surface region in the plane and/or a plane within the material thickness parallel to the outer surface, whereby a holohedral activation is to be encompassed by embodiments of the invention. Alternatively to a differentiated activation of different regions with different radiation energy, unexpanded hollow microspheres may be maintained in other subregions. In this regard, embodiments of the invention are not limited to hollow microspheres with specific properties. Rather, hollow microspheres with different properties can be introduced into the surface element.

Thereby it has already proved to be useful if the hollow microspheres are introduced into the substrate in different spatially delimited regions in varying proportions relative to the volume or mass of the hollow microspheres, in order to supply a sufficient quantity of hollow microspheres to those regions in particular, in which activation of the hollow microspheres is intended.

Another, likewise useful embodiment of the method is realized in that electromagnetic radiation in the infrared spectrum (IR) is introduced into the surface element as high-energy radiation, whereby, for example, the achievable level within the layer structure is simultaneously set by selecting the wavelength of the radiation. Hereby, the high-energy radiation can also be selectively limited to comparatively small, possibly single punctiform regions in order to create any desired structures.

Thereby, it has proved promising if, by selecting specific wavelength ranges, the hollow microspheres are expanded and/or activated in different planes spaced at different distances from the running side and/or in different longitudinal sections, for example edge sections, in order to specifically optimize the properties of the surface element in predetermined subregions.

Furthermore, it is sensible if additional fillers, especially fibrous or stranded fillers, are introduced into the wear layer. In this way, an additional reinforcement of the wear layer can be achieved, if required, in order to further improve the dimensional stability of the surface element to be manufactured. It has already been shown that by using multilayer fillers with hollow microspheres inserted in between, a considerable improvement in strength can be achieved, taking into account the total mass of the composite thus produced.

Moreover, it is also advantageous if the hollow microspheres contain active or reactive substances, which are released by the high-energy radiation, and the released substances react with components of the adjacent material of the surface element. For this purpose, the hollow microspheres are expanded until they burst or the respective shell of the hollow microspheres becomes permeable and the filler escapes. The filler thus enters the adjacent regions of the strip material as a gaseous or liquid fluid and reacts with the materials of the surface element present there. Conceivable is a hardener, for example, which leads to an irreversible reaction with the material of the wear layer in order to harden it. Alternatively, due to the expansion of the hollow microspheres also a weakening of the shell can be performed in such a way that the occlusion that occurs, when the surface element is in use, leads to a permeability of the shell. In this way, the hollow microspheres also serve as a carrier for a wear indicator substance. A color change that can be achieved in this way is visually perceptible and can therefore be used as a wear indicator.

Naturally, the dye can also be of such consistence that it is invisible under ambient conditions and only becomes detectable by light of a certain wavelength (UV).

In the case of a substance serving as a contamination indicator, the hollow microspheres contain microorganisms that react with moisture or air, for example, so that the microorganisms come into contact in the event of wear and trigger biological reactions. Naturally, the reaction partner of the microorganisms can also originate from the transport goods, for example food or chemical substances. Conversely, the substances released could also release decontaminating, disinfecting, biocidal or other active substances to protect the transport goods.

Of course, hollow microspheres can be mixed together with other additives, such as color or conductivity additives, to realize certain desired properties.

The energy for expansion of the hollow microspheres can be introduced by means of any heat source, for example, also by means of a heat transfer fluid. Advantageous thereby is if the high-energy radiation is introduced by means of a radiation source with a wavelength adapted to the region to be activated, in particular an adjustable wavelength, so that the radiation source introduces a wavelength, for example in the infrared range, into the respective region of the surface element in a freely selectable layer plane. Other regions thus remain unaffected by the high-energy radiation, so that heating is excluded there.

Creating a flexible surface element with improved properties of the wear layer is achieved according to embodiments of the invention by the flexible surface element having at least one expanded thermoplastic wear layer, produced by the expansion of hollow microspheres of the surface element against the pressure-resistant layer and subsequent at least partial removal of the pressure-resistant layer.

The possible applications and uses of the surface element according to embodiments of the invention are unlimited. For example, the surface element is also suitable as a processing or printing belt for transferring printable substances such as dyes. The compressibility required for this, which is predetermined within narrow tolerance limits, can be optimally adjusted by the pressure-resistant layer.

According to a useful embodiment of the invention, the surface element has at least one thermoplastic wear layer as well as at least one tensile member, so that the wear layer containing the hollow microspheres absorbs no or only low tensile forces during operation.

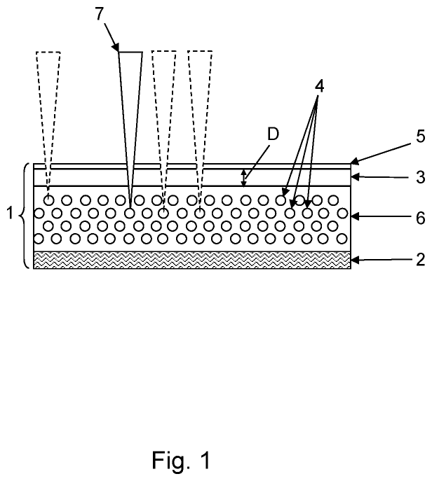

The method of manufacturing a flexible surface element 1 according to embodiments of the invention is explained in more detail below with the help of the FIGS. 1 to 3. The surface element 1 shown is intended for use in the printing industry, so that highest demands are placed on the surface properties of a thermoplastic wear layer 3 of TPU present on a tensile member 2. In a functional layer 6 with the wear layer 3 expandable hollow microspheres 4 are introduced in a uniform distribution and are not shown true to scale but are shown larger to illustrate the idea. A pressure-resistant layer 5, which does not contain hollow microspheres 4, is applied to the wear layer 3. Naturally, the hollow microspheres 4 can also be applied in an unevenly distributed manner.

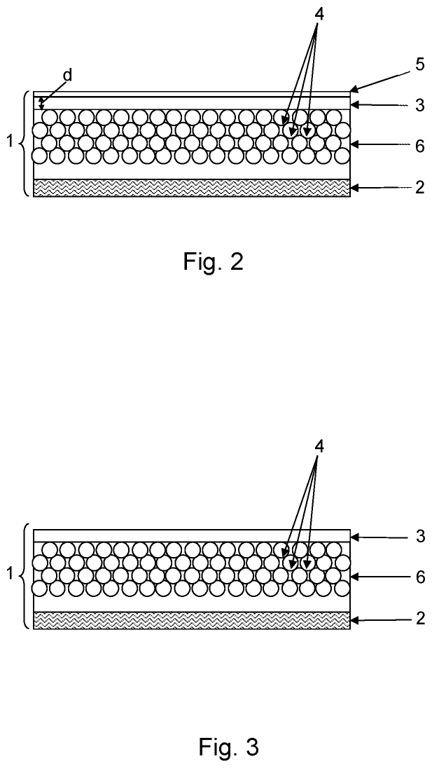

An idea according to embodiments of the invention is based on the two-dimensional or partial activation of the hollow microspheres 4 by the thermal energy supply of a high-energy radiation 7, in particular an electromagnetic radiation in the infrared spectrum, in order to heat an unshown shell of the hollow microspheres 4 above their softening temperature. For this purpose, the radiation 7 penetrates the pressure-resistant layer 5 as well as the wear layer 3 and is focused or concentrated in the desired cross-sectional plane of the functional layer 6, whereby the pressure-resistant layer 5 and the wear layer 3 are not heated or are heated only very slightly. This causes the respective hollow microspheres 4 to expand, as can be seen in FIG. 2.

The expansion of the hollow microspheres 4 at this point leads to modified mechanical properties of the surface element 1, which can thus be specifically adapted for the first time to the particular application purpose.

In addition, however, an aspect according to embodiments of the invention is the compaction of the wear layer 3 against the pressure-resistant layer 5 acting as a barrier and/or abutment, as a result of which the thickness D of the latter is lessened to a reduced thickness d. At the same time, the compact wear layer 3 produced in this way is given excellent surface properties, in particular an optimally smooth upper surface in mirror surface quality. In particular, this compensates for and/or removes all surface defects.

As shown in FIG. 3, the pressure-resistant layer is finally removed so that the upper surface of the wear layer 3 can be used.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 surface element
2 tensile member
3 wear layer
4 hollow micro sphere
5 pressure-resistant layer
6 functional layer
7 radiation
D thickness
d thickness

1. A method for manufacturing a flexible surface element with at least one thermoplastic, thermosetting and/or elastomeric wear layer, the method comprising:
introducing expandable hollow microspheres into the wear layer and/or a functional layer,
applying at least one pressure-resistant layer detachably to the wear layer,
subsequently, heating at least one section of the surface element to be treated by a thermal energy supply to a temperature within an expansion temperature range of the hollow microspheres, so that at least the hollow microspheres contained in the section to be treated are at least partially expanded and/or further expanded, wherein expansion of the hollow microspheres is limited by pressure-resistant properties of the pressure-resistant layer, and
removing the pressure-resistant layer from the wear layer at least sectionally.

2. The method according to claim 1, wherein the pressure-resistant layer comprises polyester.

3. The method according to claim 1, wherein the pressure-resistant layer comprises a biaxially pre-stretched sheet.

4. The method according to claim 1, wherein the pressure-resistant layer is partially or sectionally removed and/or modified before and/or during the heating.

5. The method according to claim 1, wherein the applying of the at least one pressure-resistant layer comprises applying several different pressure-resistant layers to the wear layer.

6. The method according to claim 1, wherein a material thickness of the wear layer is reduced as a result of the expansion of the hollow microspheres.

7. The method according to claim 1, wherein the thermal energy supply comprises a radiation that acts differently through the pressure-resistant layer in different mutually delimited regions and/or in different cross-sectional planes of the wear layer and/or the functional layer of the surface element, so that the hollow microspheres are expanded differently in the different regions and/or different cross-sectional planes of the surface element.

8. The method according to claim 1, wherein the thermal energy supply comprises an electromagnetic radiation in an infrared spectrum that is adjusted so that at least individual regions and/or cross-sectional planes of the wear layer are heated, and the pressure-resistant layer is at least substantially penetrated by the electromagnetic radiation without being heated.

9. A flexible surface element with at least one expanded wear layer, produced by expansion of hollow microspheres of the surface element against a pressure-resistant layer and subsequent at least partial removal of the pressure-resistant layer.

10. A surface element according to claim 9, wherein the pressure-resistant layer has cutouts or through-holes.
